(19) United States
(12) Patent Application Publication
(10) Pub. No.: US 2025/0006155 A1
(43) Pub. Date: Jan. 2, 2025

(54) REED

(71) Applicant: YAMAHA CORPORATION, Hamamatsu-shi (JP)

(72) Inventors: Yuichiro SUENAGA, Hamamatsu-shi (JP); Risa FUKUDA, Hamamatsu-shi (JP)

(21) Appl. No.: 18/884,314

(22) Filed: Sep. 13, 2024

Related U.S. Application Data
(63) Continuation of application No. PCT/JP2023/007802, filed on Mar. 2, 2023.

(30) Foreign Application Priority Data
Mar. 16, 2022 (JP) 2022-041911

(51) Int. Cl. G10D 9/035

(52) U.S. Cl. CPC G10D 9/035

(57) ABSTRACT

A reed comprising a base part extending in a first direction, a vamp extending from the base part in the first direction and a plurality of grooves formed on the vamp and aligned in a second direction perpendicular to the first direction. A first region of the vamp having a predetermined width in the second direction and extending in the first direction includes at least a part of a first groove when the vamp is viewed along a third direction perpendicular to the first 1 and second directions. A surface area of a groove in the first region is larger than a surface area of a groove in a second region which is located closer to a center of the vamp than the first region and extends in the first direction with a predetermined width in the second direction when the vamp is viewed along the third direction.

### CROSS-REFERENCE TO RELATED APPLICATIONS

This application is a Continuation of International Patent Application No. PCT/JP2023/007802, filed on Mar. 2, 2023, which claims the benefit of priority to Japanese Patent Application No. 2022-41911, filed on Mar. 16, 2022, the entire contents of which are incorporated herein by reference.

### FIELD

The present disclosure relates to a reed of a wind instrument.

### BACKGROUND

A reed attached to a mouthpiece of a wind instrument is formed by a plant material commonly referred to as canes. In recent years, a reed formed of a resin material has also been developed as described in Japanese Unexamined Patent Publication No. 2017-62310 and U.S. Pat. No. 4,014,241.

### SUMMARY

According to an embodiment of the present disclosure, a reed having a base part extending in a first direction, a vamp extending from the base part in the first direction, and a plurality of grooves formed on the vamp, the plurality of grooves including at least a first groove and a second groove arranged in order from a center of the vamp toward an outside of the vamp when the vamp is viewed along the first direction is provided, wherein a length of the second groove along the first direction is longer than a length of the first groove along the first direction.

According to an embodiment of the present disclosure, a reed having a base part extending in a first direction, a vamp extending from the base part in the first direction, and a plurality of grooves formed on the vamp, the plurality of grooves including at least a first groove and a second groove arranged in order from a center of the vamp toward an outside of the vamp when the vamp is viewed along the first direction is provided, wherein a cross-sectional area of the second groove, when the vamp is viewed along the first direction, is larger than a cross-sectional area of the first groove, when the vamp is viewed along the first direction.

According to an embodiment of the present disclosure, a reed having a base part extending in a first direction, a vamp extending from the base part in the first direction, and a plurality of grooves formed on the vamp, the plurality of grooves including at least a first groove and a second groove arranged in order from a center of the vamp toward an outside of the vamp when the vamp is viewed along the first direction is provided, wherein a thickness of a bottom portion of the second groove is thinner than a thickness of a bottom portion of the first groove.

According to an embodiment of the present disclosure, a reed having a base part extending in a first direction, a vamp extending from the base part in the first direction, and a plurality of grooves formed on the vamp, the plurality of grooves including at least a first grove, a second groove, a third groove and a fourth groove arranged in order from a center of the vamp to an outside of the vamp when the vamp is viewed along the first direction is provided, wherein the first groove and the second groove are adjacent to each other and the third groove and the fourth groove are adjacent to each other, and wherein a distance between the first groove and the second groove is greater than a distance between the third groove and the third groove.

According to an embodiment of the present disclosure, a reed having a base part extending in a first direction, a vamp extending from the base part in the first direction, and a plurality of grooves formed on the vamp and aligned in a second direction perpendicular to the first direction is provided, wherein a first region of the vamp having a predetermined width in the second direction and extending in the first direction includes at least a part of a first groove when the vamp is viewed along a third direction perpendicular to the first direction and the second direction, and wherein a surface area of a groove in the first region is larger than a surface area of a groove in a second region which is located closer to a center of the vamp than the first region and extends in the first direction with a predetermined width in the second direction when the vamp is viewed along the third direction.

### BRIEF DESCRIPTION OF DRAWINGS

FIG. 1 is a diagram showing a blowing part according to an embodiment.

FIG. 2 is a diagram showing a reed and a mouthpiece according to an embodiment.

FIG. 3 is an enlarged view of a part of a vamp of a reed according to an embodiment.

FIG. 4 is an enlarged view of a part of a vamp of a reed according to an embodiment.

FIG. 5 is a diagram of a reed according to an embodiment viewed from a tip side of a vamp in a first direction.

FIG. 6 is an enlarged view of a part of a vamp of a reed according to an embodiment.

FIG. 7 is a partially enlarged view of a reed according to an embodiment viewed from a tip side of a vamp in a first direction.

FIG. 8 is an enlarged view of a part of a vamp of a reed according to an embodiment.

FIG. 9 is a partially enlarged view of a reed according to an embodiment viewed from a tip side of a vamp in a first direction.

FIG. 10 is an enlarged view of a part of a vamp of a reed according to an embodiment.

FIG. 11 is a partially enlarged view of a reed according to an embodiment viewed from a tip side of a vamp in a first direction.

FIG. 12 is an enlarged view of a part of a vamp of a reed according to a modification.

FIG. 13 is a partially enlarged view of a reed according to a modification viewed from a tip side of a vamp in a first direction.

FIG. 14 is a diagram showing a reed according to a modification.

FIG. 15 is a diagram showing a reed according to a modification.

FIG. 16 is a diagram showing a reed according to a modification.

FIG. 17 is a diagram showing a reed according to a modification.

FIG. 18 is a diagram showing a reed according to a modification.

### DESCRIPTION OF EMBODIMENTS

A reed formed of a plant material (hereinafter referred to as a plant-derived reed) is different in physical properties from a reed formed of a resin material (hereinafter referred to as a resin-derived reed). Specifically, the plant-derived reed is characterized in that, at its tip, rigidity in a lateral direction substantially orthogonal to an extending direction (longitudinal direction) of a reed body is relatively low compared to rigidity in the longitudinal direction, and elastic modulus in the lateral direction is low compared to the longitudinal direction and is easily bent. On the other hand, unlike the plant-derived reed, the resin-derived reed has no anisotropy in the rigidity in the longitudinal direction and the lateral direction. Therefore, the resin-derived reed cannot reproduce a tone color of the plant-derived reed. It is desired to realize various tones by resin-derived reeds, including making sound of the resin-derived reeds closer to sound of the plant-derived reeds.

According to an embodiment of the present disclosure, various tones can be realized by a reed formed of a material other than a plant material.

Hereinafter, an embodiment of the present disclosure will be described in detail with reference to the drawings. The following embodiments are examples, and the present disclosure should not be construed as being limited to these embodiments. In the drawings referred to in the present embodiment, the same or similar parts are denoted by the same reference signs or similar reference signs (only denoted by A, B, or the like after the numerals), and duplicate description thereof may be omitted. In the drawings, dimensional ratios may be different from actual ratios, or a part of the configuration may be omitted from the drawings for clarity of explanation.

A blowing part according to an embodiment is, for example, a blowing part of a single reed used in a saxophone, and includes a reed. The reed may be formed of a plant material such as wood, a resin material, a material other than wood and the resin material, for example, an inorganic material such as metals or ceramics.

### First Embodiment

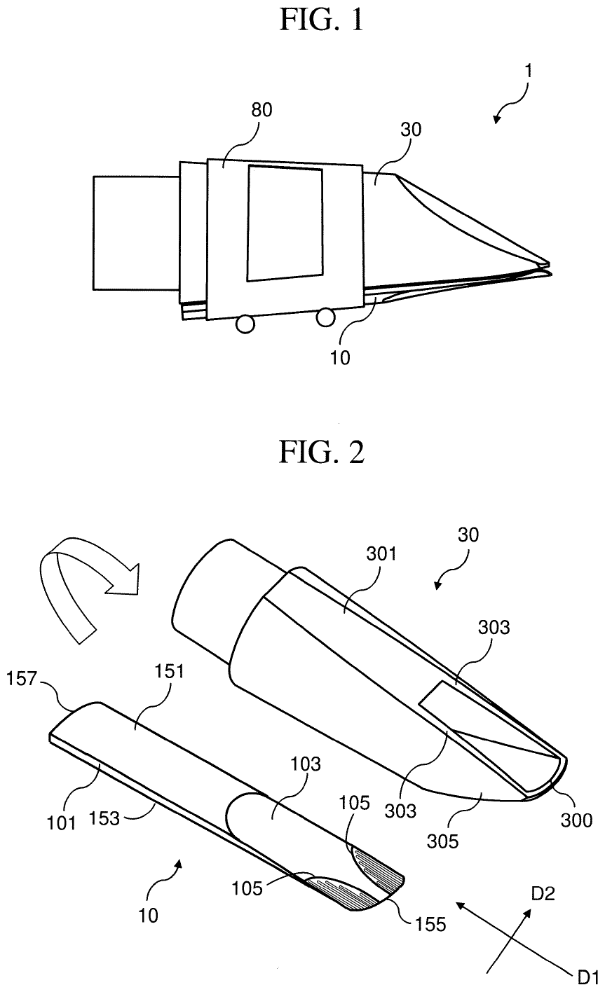

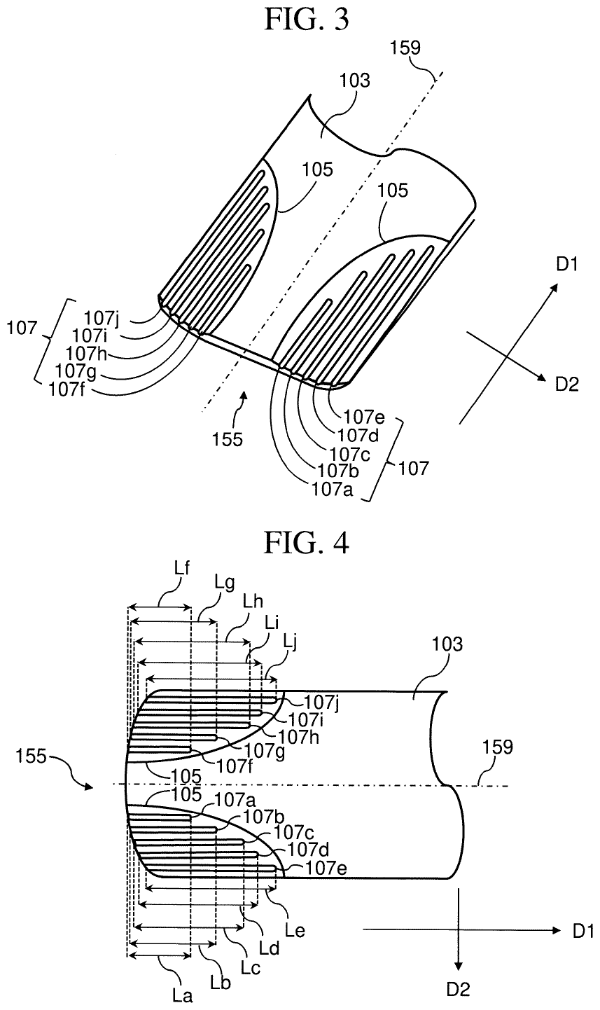

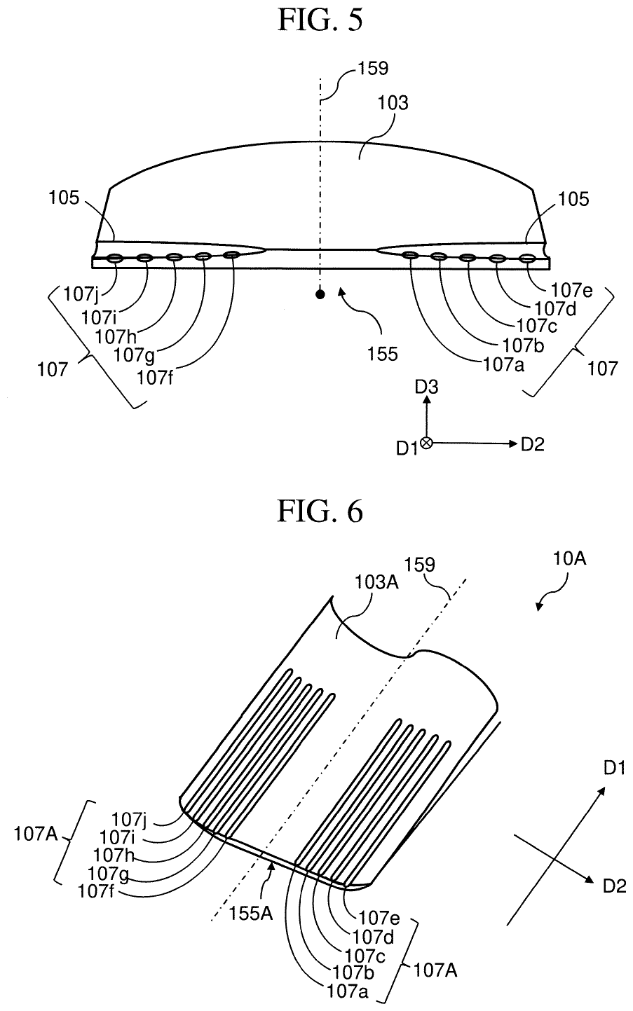

FIG. 1 is a diagram showing a blowing part 1 according to a first embodiment of the present disclosure. FIG. 1 shows an example in which the blowing part 1 is viewed from a side. FIG. 2 is a diagram showing a reed 10 and a mouthpiece 30 according to the present embodiment. FIG. 3 is an enlarged view of a part of a vamp 103 of the reed 10 according to the present embodiment. FIG. 4 is an enlarged plan view of a part of the vamp 103 of the reed 10 according to the present embodiment. FIG. 5 is a view of the reed 10 according to the present embodiment viewed from a tip side of the vamp 103 in a first direction (D1). Hereinafter, the reed 10 according to the present embodiment will be described with reference to FIG. 1 to FIG. 5.

As shown in FIG. 1, the blowing part 1 includes the reed 10, the mouthpiece 30, and a ligature 80. The ligature 80 is a member that fixes the reed 10 and the mouthpiece 30.

As shown in FIG. 2, the mouthpiece 30 includes a table 301, a side rail 303, a baffle 305, and a tip rail 300. Two side rails 303 extend from the table 301. The tip rail 300 extends from two side rails 303. The tip rail 300 and the side rails 303 are arranged at an end part of the baffle 305.

The reed 10 according to the present embodiment will be described with reference to FIG. 2 to FIG. 5. In the present embodiment, the reed 10 is made of a resin-based material, and includes a base part 101 and the vamp 103. As shown in FIG. 2, the base part 101 includes a planar portion 151, a back surface 153, and a heel 157. The planar portion 151 is arranged on at least one surface of the base part 101. The back surface 153 is a surface opposite to the planar portion 151. In this example, the back surface 153 corresponds to at least a part of a plane that contacts the table 301 when the reed 10 is attached to the mouthpiece 30.

The vamp 103 extends from the base part 101 on an opposite side to the heel 157. That is, the vamp 103 is arranged at one end portion of the first direction D1 (longitudinal direction), which is an extending direction of the reed 10, and a thickness thereof gradually decreases toward a tip 155 of in first direction D1.

The vamp 103 may be provided with recesses 105. In the reed 10 according to the present embodiment, two recesses 105 are provided on the vamp 103. The two recesses 105 are respectively arranged at one end of the vamp 103 on an opposite side of the base part 101. The two recesses 105 may be arranged to be aligned along a second direction D2 (lateral direction). The second direction D2 is perpendicular to the first direction D1. Further, a plane formed by the first direction D1 and the second direction D2 corresponds to the back surface 153 of the reed 10, which is opposite to the plane portion 151. In addition, in the two recesses 105, a thickness of the vamp 103 gradually decreases toward the tip 155 of the vamp 103 on the side opposite to the base part 101 side. Further, in the two recesses 105, the thickness of the vamp 103 gradually decreases from a center 159 toward an outside, in other words, toward an end portion of the vamp 103 on the second direction D2 side when the vamp 103 is viewed from the tip 155 side of the vamp 103 in the first direction D1.

Each of the two recesses 105 includes a plurality of grooves 107. In FIG. 3 to FIG. 5, although the plurality of grooves 107 includes grooves 107a to 107j, in the present embodiment, the number of grooves is not particularly limited. Hereinafter, in the case where grooves in the plurality of grooves 107 are not distinguished from each other, they are simply referred to as grooves 107, and in the case where the grooves in the plurality of grooves 107 are distinguished from each other, they are referred to as grooves 107a to 107j.

The plurality of grooves 107 may extend, for example, in the first direction D1 from the tip 155 of the vamp 103. Further, the plurality of grooves 107 may be arranged, for example, to be aligned along the second direction D2. In other words, the plurality of grooves 107 are arranged to be aligned outward from the center 159 when the vamp 103 is viewed from the tip 155 of the vamp 103 in the first direction D1. In FIG. 3 to FIG. 5, as an example, the grooves 107a to 107e are arranged to be aligned outward from the center 159 on one side and the grooves 107f to 107j are arranged to be aligned outward from the center 159 on the other side with the center 159 interposed therebetween. However, in the present embodiment, an extending direction of the plurality of grooves 107 is not limited to the first direction D1, and an aligning direction of the plurality of grooves 107 is not limited to the second direction D2.

Although shapes of the plurality of grooves 107 are not particularly limited, in the present embodiment, as an example, a case where the shape of each of the plurality of grooves 107 are U-shape is shown. Here, the “U-shape” means a shape including a bottom surface, a side surface, and a curved surface connecting the bottom surface and the side surface. In the present embodiment, depths of the plurality of grooves 107 may be the same. Here, the depth of the groove means a distance from a surface of the vamp 103 in which the grooves 107 are formed to the deepest portion of the U-shaped groove 107.

Among the plurality of grooves 107, the grooves 107 arranged outward from the center 159 (in second direction D2) have a longer length. For example, a length may gradually increase from the groove 107a arranged closest to the center 159 to the groove 107e arranged outermost. That is, when a length La of the groove 107a arranged closest to the center 159 is compared with a length Lb of the groove 107b adjacent to the groove 107a, the length Lb of the groove 107b is longer than the length La of the groove 107a. That is, a relationship between the length La and the length Lb is Lb>La. Similarly, when the length Lb of the groove 107b is compared with a length Lc of the groove 107c adjacent to the groove 107b and arranged more outwardly than the groove 107b, the length Lc of the groove 107c is longer than the length Lb of the groove 107b. That is, a relationship between the length Lb and the length Lc is Lc>Lb. Similarly, when the length 107c of the groove Lc is compared with a length Ld of the groove 107d adjacent to the groove 107c and arranged more outwardly than the groove 107c, the length Ld of the groove 107d is longer than the length Lc of the groove 107c. That is, a relationship between the length Lc and the length Ld is Ld>Lc. Similarly, when the length Ld of the groove 107d is compared with a length Le of the groove 107e adjacent to the groove 107d and arranged on the outermost side, the length Le of the groove 107e is longer than the length Ld of the groove 107d. That is, a relationship between the length Le and the length Ld is Le>Ld.

Similarly, among the plurality of grooves 107, a length Lg of the groove 107g is longer than a length Lf of the groove 107f (Lg>Lf), a length Lh of the groove 107h is longer than the length Lg of the groove 107g (Lh>Lg), a length Li of the groove 107i is longer than the length Lh of the groove 107h (Li>Lh), and a length Lj of the groove 107j is longer than the length Li of the groove 107i (Lj>Li).

The reed 10 according to the present embodiment has the plurality of grooves 107 in the vamp 103 which have an increasing length so as to be arranged outwardly from the center 159. As a result, on a side of the tip 155 of the vamp 103, rigidity in the second direction D2 (lateral direction) perpendicular to the first direction D1 (longitudinal direction) which is the extending direction (longitudinal direction) of the reed 10 outward from the center 159 of the vamp 103 is lower than rigidity in the first direction D1 (longitudinal direction). As a consequence, elastic modulus in the second direction D2 (lateral direction) is lower than elastic modulus in the first direction D1 (longitudinal direction) on the tip 155 side of the vamp 103, and is more easily bent. Therefore, when the reed 10 is attached to the mouthpiece 30 and the saxophone is blown, both ends of the tip 155 of the vamp 103 on the second D2 side are bent in advance and vibrate so as to touch the mouthpiece 30. Thus, even in the reed 10 formed of the resin material, the same tone color as that of the plant-derived reed can be realized.

The reed formed of a resin material has high rigidity and no anisotropy in rigidity, and therefore it is difficult to realize a tone color of a plant-derived reed. If lateral rigidity of the reed is reduced by reducing a thickness of the reed, longitudinal rigidity of the reed is also unnecessarily reduced. Further, if a groove along an extending direction of the reed is arranged in the entire reed formed of a resin material, rigidity of the entire reed is reduced, and when a saxophone is blown, a reaction of the reed is dulled and a pitch of a high-frequency range is easily dropped. As described above, in the present embodiment, the plurality of grooves 107 having a length that gradually increases outward from the center 159 are arranged on the tip 155 side of the vamp 103 of the reed 10. Accordingly, rigidity of an end portion on the second direction D2 side of the vamp 103 can be reduced outward from the center 159 side without reducing the rigidity of the entire reed 10, and anisotropy of the rigidity similar to anisotropy of rigidity of the plant-derived reed can be imparted to the reed 10. Further, since the plurality of grooves 107 are shallowly provided at both ends of the second direction D2 located on the tip 155 side of the vamp 103, when a player puts his/her mouth on the blowing part 1 to which the reed 10 is attached, tactile feeling of the lips is not uncomfortable.

Although the reed 10 formed of a resin material has been described in the present embodiment, the reed according to the present embodiment is not limited to a reed formed of a resin material. In addition to the resin material, by applying a groove arranged in the reed 10 of the present embodiment to a reed formed of an inorganic material such as a plant material such as wood, a metal, or ceramics, it is possible to realize the same tone color as that of the plant-derived reed as in the case of the reed 10.

In the present embodiment, the plurality of grooves 107 is arranged in the recesses 105 of the vamp 103. As described above, in the recesses 105, the thickness of the vamp 103 gradually decreases outward from the center 159, in other words, toward the end portion of the vamp 103 on the second direction D2 side when the vamp 103 is viewed in the first direction D1 from the tip 155 side of the vamp 103. Therefore, the recesses 105 contribute to reducing rigidity of the end portion on the second direction D2 side of the vamp 103 outward from the center 159 side together with the plurality of grooves 107. However, the present embodiment is not limited to this, and the recesses 105 may be omitted.

### Second Embodiment

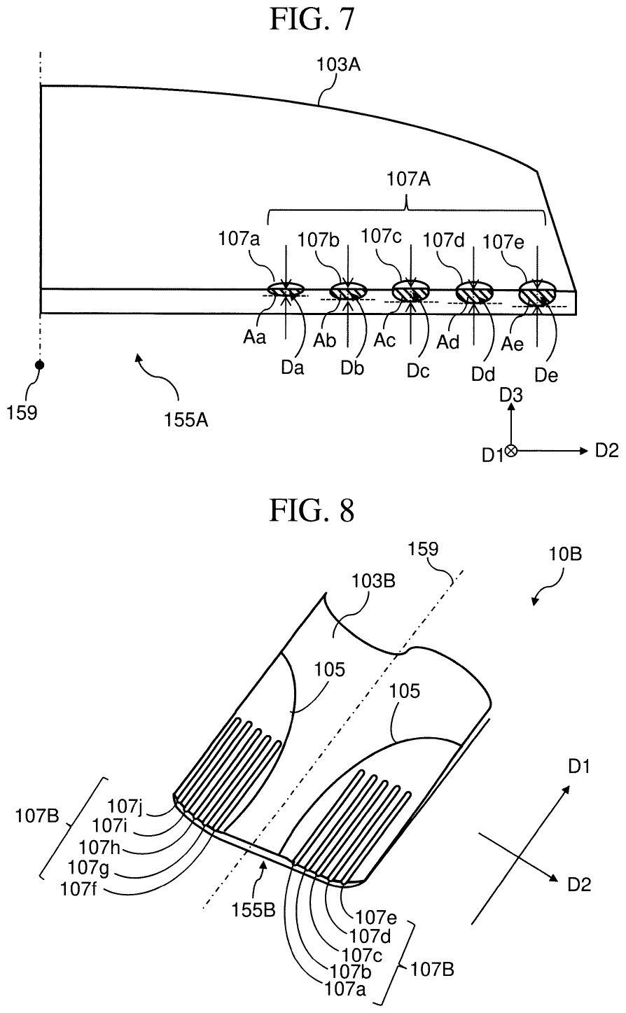

FIG. 6 is an enlarged view of a part of a vamp 103A of a reed 10A according to a second embodiment of the present disclosure. FIG. 7 is a partially enlarged view of the reed 10A according to the present embodiment as viewed from a tip 155A of the vamp 103A in the first direction (D1). Referring to FIG. 6 and FIG. 7, the reed 10A according to the present embodiment will be described below.

An entire structure of the reed 10A according to the present embodiment is substantially the same as the entire structure of the reed 10 except that no recess is arranged on the vamp, and shapes of a plurality of grooves arranged on the vamp differs from the shapes of the plurality of grooves 107 arranged in the reed 10 according to the first embodiment. Hereinafter, configurations of the reed 10A that differ from the reed 10 according to the first embodiment will be described.

The vamp 103A of the reed 10A according to the present embodiment is provided with a plurality of grooves 107A. In the present embodiment, although the plurality of grooves 107A includes the grooves 107a to 107j, the number of grooves is not particularly limited. Similar to the plurality of grooves 107 provided with the vamp 103 of the reed 10 according to the first embodiment, for example, the plurality of grooves 107A may extend in the first direction D1 and be arranged to be aligned along the second direction D2. In other words, the plurality of grooves 107A is arranged to be aligned from the center 159 toward an outside when the vamp 103A is viewed from the tip 155A of the vamp 103A in the first direction D1. In FIG. 6 and FIG. 7, for example, the grooves 107a to 107e are arranged to be aligned outward from the center 159 on one side, and the grooves 107f to 107j are arranged to be aligned outward from the center 159 on the other side with the center 159 interposed therebetween. However, in the present embodiment, an extending direction of the plurality of grooves 107A is not limited to the first direction D1, and an aligning direction of the plurality of grooves 107A is not limited to the second direction D2.

Although the shapes of the plurality of grooves 107A are not particularly limited, the present embodiment exemplifies a case where the shapes of the plurality of grooves 107A are U-shape. Hereinafter, in the case where grooves in the plurality of grooves 107A are not distinguished from each other, they are simply referred to as grooves 107A, and in the case where the grooves in the plurality of grooves 107A are distinguished from each other, they are referred to as grooves 107a to 107j.

Lengths of the grooves 107a to 107j in the first direction D1 included in the plurality of grooves 107A may be the same. Unlike the plurality of grooves 107 in the first embodiment, in the present embodiment, when the vamp 103A is viewed from the tip 155A of the vamp 103A in the first direction D1, a cross-sectional area thereof is larger as the groove 107A is arranged outward from the center 159 (in second direction D2). Here, the cross-sectional area of the groove 107A means an area of the groove 107A on a plane formed by the second direction D2 which is the arrangement direction of the grooves 107A and a third direction D3 when the vamp 103A is viewed from the tip 155A of the vamp 103A in the first direction D1. The third direction D3 is a depth direction of the grooves 107A and is perpendicular to the first direction D1 and the second direction D2.

Referring to FIG. 7, when a cross-sectional area Aa of the groove 107a arranged closest to the center 159 is compared with a cross-sectional area Ab of the groove 107b adjacent to the groove 107a, the cross-sectional area Ab of the groove 107b is larger than the cross-sectional area Aa of the groove 107a. That is, a relationship between the cross-sectional area Aa and the cross-sectional area Ab is Ab>Aa. Similarly, when the cross-sectional area Ab of the groove 107b is compared with a cross-sectional area Ac of the groove 107c adjacent to the groove 107b and arranged on an outside of the groove 107b, the cross-sectional area Ac of the groove 107c is larger than the cross-sectional area Ab of the groove 107b. That is, a relationship between the cross-sectional area Ab and the cross-sectional area Ac is Ac>Ab. Similarly, when the cross-sectional area Ac of the groove 107c is compared with a cross-sectional area Ad of the groove 107d adjacent to the groove 107c and arranged on an outside of the groove 107c, the cross-sectional area Ad of the groove 107d is larger than the cross-sectional area Ac of the groove 107c. That is, a relationship between the cross-sectional area Ac and the cross-sectional area Ad is Ad>Ac. Similarly, when the cross-sectional area Ad of the groove 107d is compared with a cross-sectional area Ae of the groove 107e adjacent to the groove 107d and arranged on the outermost side, the cross-sectional area Ae of the groove 107e is larger than the cross-sectional area Ad of the groove 107d. That is, a relationship between the cross-sectional area Ad and the cross-sectional area Ae is Ae>Ad.

In the present embodiment, for example, the grooves 107a to 107e provided on the vamp 103A have the same width in the second direction D2 and differ in depth in the grooves 107a to 107e. That is, lengths of the third direction D3 of the grooves 107a to 107e differ from each other. Specifically, the depth of the grooves 107a to 107e are as deep as groove 107A arranged outwardly from the center 159 when the vamp 103A is viewed from the tip 155A side of the vamp 103A to the first direction D1.

For example, the depth may gradually increase from the groove 107a arranged closest to the center 159 to the groove 107e arranged outermost. That is, when a depth Da of the groove 107a arranged closest to the center 159 is compared with a depth Db of the groove 107b adjacent to the groove 107a, the depth Db of the groove 107b is deeper than the depth Da of the groove 107a. That is, a relationship between the depth Da and the depth Db is Db>Da. Similarly, when the depth 107b of the groove Db is compared with a depth Dc of the groove 107c adjacent to the groove 107b and arranged more outwardly than the groove 107b, the depth Dc of the groove 107c is deeper than the depth 107b. That is, a relationship between the depth Db and the depth Dc is Dc>Db. Similarly, when the depth Dc of the groove 107c is compared with a depth Dd of the groove 107d adjacent to the groove 107c and arranged more outwardly than the groove 107c, the depth Dd of the groove 107d is deeper than the depth 107c. That is, a relationship between the depth Dc and the depth Dd is Dd>Dc. Similarly, when the depth Dd of the groove 107d is compared with a depth De of the groove 107e adjacent to the groove 107d and arranged on the outermost side, the depth De of the groove 107e is deeper than the depth Dd of the groove 107d. That is, a relationship between the depth Dd and the depth De is De>Dd.

Although not shown, similarly to the grooves 107a to 107e, when a cross-sectional area of the groove 107f arranged closest to the center 159 is compared with a cross-sectional area of the groove 107g adjacent to the groove 107f, the cross-sectional area of the groove 107g is larger than the cross-sectional area of the groove 107f. Similarly, when the cross-sectional area of the groove 107g is compared with a cross-sectional area of the groove 107h which is arranged adjacently to the groove 107g and more outwardly than the groove 107g, the cross-sectional area of the groove 107h is larger than the cross-sectional area of the groove 107g. Similarly, when the cross-sectional area of the groove 107h is compared with a cross-sectional area of the groove 107i which is arranged adjacently to the groove 107h and more outwardly than the groove 107h, the cross-sectional area of the groove 107i is larger than the cross-sectional area of the groove 107h. Similarly, when the cross-sectional area of the groove 107i compared with a cross-sectional area of the groove 107j adjacent to the groove 107i and arranged outermost, the cross-sectional area of the groove 107j is larger than the cross-sectional area of the groove 107i.

For example, the grooves 107f to 107j provided on the vamp 103A have the same width in the second direction D2 and differ in depth in the grooves 107f to 107j. That is, lengths of the third direction D3 of the grooves 107f to 107j differ from each other. Specifically, the depths of the grooves 107f to 107j are as deep as the groove 107A is arranged outwardly from the center 159 when the vamp 103A is viewed from the tip 155A of the vamp 103A in the first direction D1. For example, the depth may gradually increase from the groove 107f arranged closest to the center 159 to the groove 107j arranged outermost.

In the present embodiment, the plurality of grooves 107A are provided so that the cross-sectional area of the groove 107A increases outwardly from the center 159 of the vamp 103A. As a result, on the tip 155A side of the vamp 103A, rigidity in the second direction D2 (lateral direction), that is perpendicular to the first direction (longitudinal direction) that is an extending direction (longitudinal direction) of the reed 10A, from the center 159 of the vamp 103A outward, is lower than rigidity in the first direction D1. As a consequence, elastic modulus in the second direction D2 (lateral direction) is lower than elastic modulus in the first direction D1 (longitudinal direction) on the tip 155A side of the vamp 103A and is more easily bent. In other words, anisotropy of rigidity similar to anisotropy of rigidity of a plant-derived reed can be imparted to the reed 10A. Thus, even in the case of the reed 10A formed of a resin material, a similar tone color as that of the plant-derived reed can be realized.

In the above description, the grooves 107a to 107e and the grooves 107f to 107j provided on the vamp 103A have the same width in the second direction D2, and the depths of the grooves 107a to 107e and the depths of the grooves 107f to 107j gradually become deeper from the groove 107a or the groove 107f arranged closest to the center 159 toward the groove 107e or the groove 107j arranged outermost in the second direction D2. However, when the vamp 103A is viewed from the tip 155A of the vamp 103A in the first D1, as long as the cross-sectional area of the grooves 107A arranged outwardly from the center 159 is larger, the present embodiment is not limited to this. For example, the depths of the plurality of grooves 107A, that is, the lengths in the third direction D3 are all the same, and the width of the groove 107A arranged outwardly from the center 159 may be wider when the vamp 103A is viewed from the tip 155A of the vamp 103A in the first direction D1. That is, the groove 107A arranged outwardly from the center 159 may have a longer length in the second direction D2. For example, in the grooves 107a to 107e, the width may gradually increase from the groove 107a arranged closest to the center 159 to the groove 107e arranged outermost. Similarly, in the grooves 107f to 107j, the width may gradually increase from the groove 107f arranged closest to the center 159 to the groove 107j arranged outermost.

### Third Embodiment

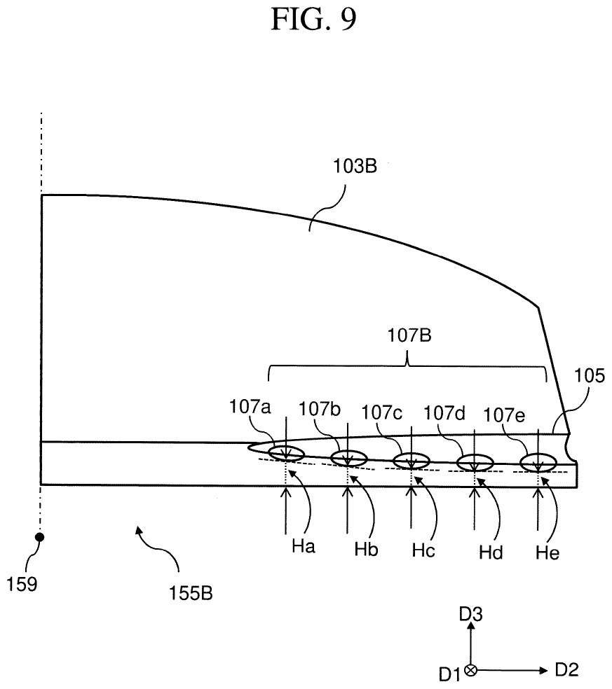

FIG. 8 is an enlarged view of a part of a vamp 103B of a reed 10B according to a third embodiment of the present disclosure. FIG. 9 is a partially enlarged view of the reed 10B according to the present embodiment as viewed from a tip 155B of the vamp 103B in the first direction (D1). Referring to FIG. 8 and FIG. 9, the reed 10B according to the present embodiment will be described below.

An entire structure of the reed 10B according to the present embodiment is substantially the same as the entire structure of the reed 10 except that a shape of a plurality of grooves arranged in a vamp 103B differs from the shape of the plurality of grooves 107 arranged in the reed 10 according to the first embodiment, and therefore, overlapping explanation will be omitted. Hereinafter, a configuration of the reed 10B that differs from the reed 10 according to the first embodiment will be described.

Two recesses 105 are provided on the vamp 103B of the reed 10B according to the present embodiment. Each of the two recesses 105 is provided with a plurality of grooves 107B. In the present embodiment, although the plurality of grooves 107B includes the grooves 107a to 107j, the number of grooves is not particularly limited. Similar to the plurality of grooves 107 arranged on the vamp 103 of the reed 10 according to the first embodiment, for example, the plurality of grooves 107B may extend in the first direction D1 and be arranged to be aligned in the second direction D2. In other words, the plurality of grooves 107B are arranged to be aligned from the center 159 toward an outside when the vamp 103B is viewed from a tip 155B of the vamp 103B in the first direction D1. In FIG. 8 and FIG. 9, for example, the grooves 107a to 107e are arranged to be aligned outward from the center 159, and the grooves 107f to 107j are arranged to be aligned outward from the center 159 on the other side with the center 159 interposed therebetween. However, in the present embodiment, an extending direction of the plurality of grooves 107B is not limited to the first direction D1, and an aligning direction of the plurality of grooves 107B is not limited to the second direction D2.

Although shapes of the plurality of grooves 107B are not particularly limited, the present embodiment exemplifies a case where the shapes of the plurality of grooves 107B are U-shape. Hereinafter, in the case where grooves in the plurality of grooves 107B are not distinguished from each other, they are simply referred to as grooves 107B, and in the case where the grooves in the plurality of grooves 107B are distinguished from each other, they are referred to as grooves 107a to 107j.

Lengths of the grooves 107a to 107j included in the plurality of grooves 107B in the first direction D1 may be the same. In addition, widths and depths of the grooves 107a to 107j included in the plurality of grooves 107B in the second direction and the third direction may be the same. In the present embodiment, thickness of bottom parts of the grooves 107a to 107j is thinner as the groove 107B is arranged outwardly from the center 159 when the vamp 103B is viewed from the tip 155B of the vamp 103B in the first direction D1. For example, in the grooves 107a to 107e, the thickness of the bottom part may gradually decrease from the groove 107a arranged closest to the center 159 to the groove 107e arranged outermost in second direction D2. Here, the thickness of a bottom part of the groove 107B means a distance from the deepest point of the U-shaped groove 107B to a surface (back surface 153) opposite to a surface arranged with the vamp 103B of the reed 10B when the vamp is viewed from the tip 155B of the vamp 103B in the first direction D1.

In the present embodiment, when a thickness Ha of the bottom part of the groove 107a arranged closest to the center 159 is compared with a thickness Hb of the bottom part of the groove 107b adjacent to the groove 107a, the thickness Hb of the bottom part of the groove 107b is thinner than the thickness Ha of the bottom part of the groove 107a. That is, a relationship between the thickness Ha of the bottom part and the thickness Hb of the bottom part is Hb<Ha. Similarly, when the thickness 107b of the bottom part of the groove Hb is compared with a thickness Hc of the bottom part of the groove 107c adjacent to the groove 107b and more outwardly than the groove 107b, the thickness Hc of the bottom part of the groove 107c is thinner than the thickness Hb of the bottom part of the groove 107b. That is, a relationship between the thickness Hb of the bottom part and the thickness Hc of the bottom part is Hc<Hb. Similarly, when the thickness Hc of the bottom part of the groove 107c is compared with a thickness Hd of the bottom part of the groove 107d adjacent to the groove 107c and more outwardly than the groove 107c, the thickness Hd of the bottom part of the groove 107d is thinner than the thickness Hd of the bottom part of the groove 107c. That is, a relationship between the thickness Hc of the bottom part and the thickness Hd of the bottom part is Hd<Hc. Similarly, when the thickness Hd of the bottom part of the groove 107d is compared with a thickness He of the bottom part of the groove 107e adjacent to the groove 107d and arranged outermost in the second direction D2, the thickness He of the bottom part of the groove 107e is thinner than the thickness Hd of the bottom part of the groove 107d. That is, a relationship between the thickness Hd of the bottom part and the thickness He of the bottom part is He<Hd.

Although not shown, similar to the grooves 107a to 107e, in the grooves 107f to 107j, thickness of the bottom parts thereof may gradually decrease from the groove 107f arranged closest to the center 159 to the groove 107j arranged outermost. That is, when the thickness of the bottom part of the groove 107f arranged closest to the center 159 is compared with the thickness of the bottom part of the groove 107g adjacent to the groove 107f, the thickness of the bottom part of the groove 107g is thinner than the thickness of the bottom part of the groove 107f. Similarly, when the thickness of the bottom part of the groove 107g is compared with the thickness of the bottom part of the groove 107h adjacent to the groove 107g and more outwardly than the groove 107g, the thickness of the bottom part of the groove 107h is thinner than the thickness of the bottom part of the groove 107g. Similarly, when the thickness of the bottom part of the groove 107h is compared with the thickness of the bottom part of the groove 107i adjacent to the groove 107h and more outwardly than the groove 107h, the thickness of the bottom part of the groove 107i is thinner than the thickness of the bottom part of the groove 107h. Similarly, when the thickness of the bottom part of the groove 107i is compared with the thickness of the bottom part of the groove 107j adjacent to the groove 107i and arranged outermost, the thickness of the bottom part of the groove 107j is thinner than the thickness of the bottom part of the groove 107i.

In the present embodiment, a thickness of a bottom part of a groove 107B is made thinner toward the outside from the center 159 of the vamp 103B. As a result, on the tip 155B side of the vamp 103B, rigidity in the second direction D2 (lateral direction), that is perpendicular to the first direction (longitudinal direction) that is an extending direction (longitudinal direction) of the reed 10B, from the center 159 of the vamp 103B outward, is lower than rigidity in the first direction D1. As a consequence, elastic modulus in the second direction D2 (lateral direction) is lower than elastic modulus in the first direction D1 (longitudinal direction) on the tip 155B side of the vamp 103B and is more easily bent. In other words, anisotropy of rigidity similar to anisotropy of rigidity of a plant-derived reed can be imparted to the reed 10B. Thus, even in the case of the reed 10B formed of a resinous material, the same tone color as that of the plant-derived reed can be realized.

### Fourth Embodiment

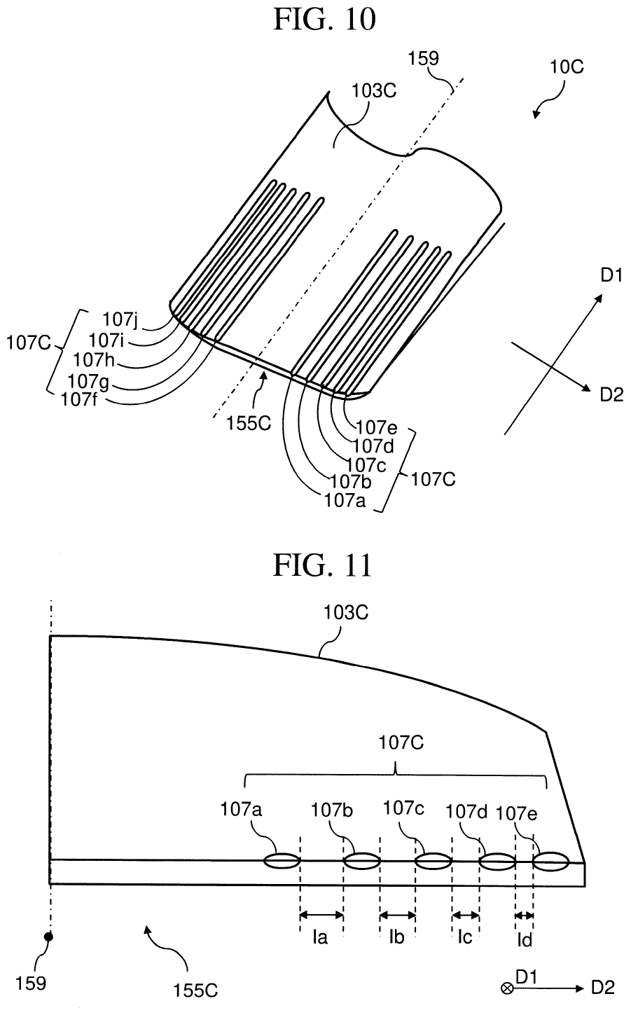

FIG. 10 is an enlarged view of a part of a vamp 103C of a reed 10C according to a fourth embodiment of the present disclosure. FIG. 11 is a partially enlarged view of the reed 10C according to the present embodiment as viewed from a tip 155C of the vamp 103C in the first direction (D1). Referring to FIG. 10 and FIG. 11, the reed 10C according to the present embodiment will be described below.

An entire structure of the reed 10C according to the present embodiment is substantially the same as the entire structure of the reed 10A except that shape of the plurality of grooves provided on the vamp 103C differ from the shapes of the plurality of grooves 107 provided on the reed 10A according to the second embodiment, and therefore, duplicate description will be omitted. Hereinafter, a configuration of the reed 10C that differs from the reed 10A according to the second embodiment will be described.

The vamp 103C of the reed 10C according to the present embodiment is provided with a plurality of grooves 107C. In the present embodiment, although the plurality of grooves 107C include the grooves 107a to 107j, the number of grooves is not particularly limited. For example, the plurality of grooves 107C may extend in the first direction D1 and be arranged to be aligned along the second direction D2. In other words, the plurality of grooves 107C are arranged to be aligned from the center 159 toward an outside when viewed from the tip 155C of the vamp 103C. In FIG. 10 and FIG. 11, for example, grooves 107a to 107e are arranged to be aligned from the center 159 toward the outside on one side, and grooves 107f to 107j are arranged to be aligned from the center 159 toward the outside on the other side with the center 159 interposed therebetween. However, in the present embodiment, an extending direction of the plurality of grooves 107C is not limited to the first direction D1, and an aligning direction of the plurality of grooves 107C is not limited to the second direction D2.

Although shapes of the plurality of grooves 107C are not particularly limited, the present embodiment exemplifies a case where the shapes of the plurality of grooves 107C are U-shape. Hereinafter, in the case where grooves in the plurality of grooves 107C are not distinguished from each other, they are simply referred to as grooves 107C, and in the case where the grooves in the plurality of grooves 107C are distinguished from each other, they are referred to as grooves 107a to 107j.

In the reed 10A according to the second embodiment described above, when the vamp 103A is viewed from the tip 155A of the vamp 103A in the first direction D1, the cross-sectional area is larger as the groove 107A is arranged from the center 159 toward the outside (second direction D2). On the other hand, in the present embodiment, cross-sectional areas of the plurality of grooves 107C provided on the vamp 103C may have the same size. Unlike the second embodiment, in the present embodiment, in the plurality of grooves 107C, a distance I between the predetermined groove 107C and the groove 107C adjacent to the predetermined groove 107C becomes smaller toward the outside from the center 159 when the vamp 103C is viewed from the tip 155C of the vamp 103C in the first direction D1.

For example, in the grooves 107a to 107e, the distance I between the adjacent grooves 107C may gradually decrease from the groove 107a arranged closest to the center 159 to the groove 107e arranged outermost. Here, the distance I between the grooves 107C adjacent to each other means a distance between an end portion of the first groove 107C in the second direction D2 and an end portion of the second groove 107C adjacent to the first groove 107C in the second direction D2 which is faced to the end portion of the first groove 107C when the vamp 103C is viewed from the tip 155C of the vamp 103C in the first direction D1.

For example, if a distance between the groove 107a arranged closest to the center 159 and the groove 107b adjacent to the groove 107a is Ia, and a distance between the groove 107b and the groove 107c arranged adjacent to the groove 107b and more outwardly than the groove 107b is taken as Ib, the distance Ia is greater than the distance Ib. That is, a relationship between the distance Ia and the distance Ib is Ia>Ib. Similarly, if a distance between the groove 107c and the groove 107d arranged adjacent to the groove 107c and more outwardly than the groove 107c is taken as Ic, the distance Ib is larger than the distance Ic. That is, a relationship between the distance Ib and the distance Ic is Ib>Ic. Similarly, if a distance between the groove 107d and the groove 107e arranged adjacent to the groove 107d and arranged outermost is taken as Id, the distance Ic is greater than the distance Id. That is, a relationship between the distance Ic and the distance Id is Ic>Id. In other words, in the present embodiment, density of the groove 107C per unit area in the vamp 103C increases outwardly from the center 159 of the vamp 103C.

Although not shown, similar to the grooves 107a to 107e, in the grooves 107f to 107j, the distance I between the adjacent groove 107C may gradually decrease. That is, a distance between the groove 107f arranged closest to the center 159 and the groove 107g adjacent to the groove 107f is greater than a distance between the groove 107g and the groove 107h arranged adjacent to the groove 107g and more outwardly than the groove 107g. Similarly, the distance between the groove 107g and the groove 107h is greater than a distance between the groove 107h and the groove 107i arranged adjacent to the groove 107h and more outwardly than the groove 107h. Similarly, the distance between the groove 107h and the groove 107i is greater than a distance between the groove 107i and the groove 107j adjacent to the groove 107i and is outermost.

In the present embodiment, the plurality of grooves 107C is arranged so that density of the groove 107C per unit area in the vamp 103C increases outwardly from the center 159 of the vamp 103C. As a result, on the tip 155C side of the vamp 103C, rigidity in the second direction D2 (lateral direction), that is perpendicular to the first direction (longitudinal direction) that is an extending direction (longitudinal direction) of the reed 10C, from the center 159 of the vamp 103C outward, is lower than rigidity in the first direction D1. As a consequence, elastic modulus in the second direction D2 (lateral direction) is lower than elastic modulus in the first direction D1 (longitudinal direction) on the tip 155C side of the vamp 103C and is more easily bent. In other words, anisotropy of rigidity similar to anisotropy of rigidity of a plant-derived reed can be imparted to the reed 10C. Thus, even in the case of the reed 10C formed of a resin material, the same tone color as that of a plant-derived reed can be realized.

### [Modifications]

The present disclosure is not limited to the embodiments described above, and includes various other modifications. For example, the embodiments described above have been described in detail for the purpose of explaining the present disclosure in an easy-to-understand manner, and are not necessarily limited to those having all the described configurations. That is, a part of the configuration of each embodiment may be replaced with another configuration or may be deleted. Some modification examples will be described below. The modifications described below can be applied to any one of the first to fourth embodiments described above. In the following description, although a predetermined embodiment may be described as a modification, another embodiment may be applied as a modification. Further, each of the modifications may be applied to a predetermined embodiment in combination as long as there is no mutual inconsistency.

### [Modification 1]

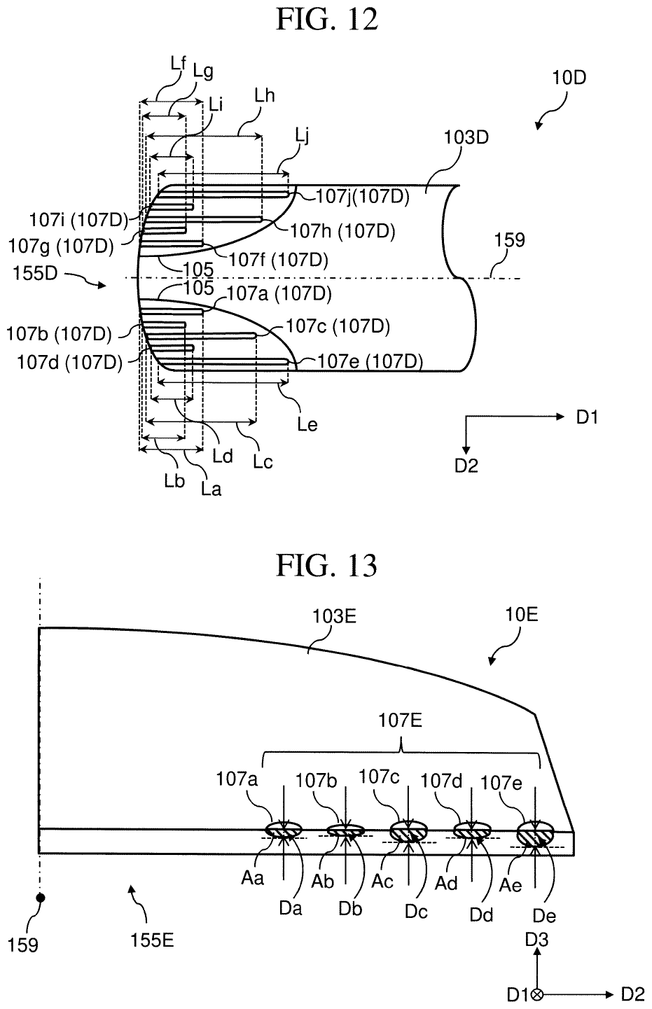

FIG. 12 is an enlarged view of a part of a vamp 103D of a reed 10D according to a modification 1. The reed 10D has substantially the same configuration as the reed 10 according to the first embodiment except that lengths of a plurality of grooves 107D arranged in the vamp 103D differ from the plurality of grooves 107 arranged in the reed 10 according to the first embodiment in part.

As shown in FIG. 12, in the reed 10D of the modification 1, a length of part of the groove 107D in the plurality of grooves 107D provided on the vamp 103D is longer as it is arranged outwardly from the center 159 (toward the second direction D2). For example, in the groove 107a to the groove 107e, when a length La of the groove 107a arranged closest to the center 159 is compared with a length Lc of the groove 107c arranged more outwardly than the groove 107a, the length Lc of the groove 107c is longer than the length La of the groove 107a. Similarly, when the length Lc of the groove 107c is compared a length Le of the outermost groove 107e, the length Le of the groove 107e is longer than the length Lc of the groove 107c. On the other hand, a length Lb of the groove 107b which is arranged adjacently to the groove 107a and more outwardly than the groove 107a is shorter than the length of the groove La. In addition, a length Ld of the groove 107d, which is arranged adjacently to the groove 107c and is arranged more outwardly than the groove 107c, is shorter than a length Lc of the groove 107c.

Similarly, in the groove 107f to the groove 107j, when a length Lf of the groove 107f arranged closest to the center 159 is compared with a length Lh of the groove 107h arranged outwardly from the groove 107f, the length Lh of the groove 107h is longer than the length Lf of the groove 107f. Similarly, when a length Lh of the groove 107h is compared with a length Lj of the outermost groove 107j, the length Lj of the groove 107j is longer than the length Lh of the groove 107h. On the other hand, the length Lg of the groove 107g which is arranged adjacently to the groove 107f and more outwardly than the groove 107f is shorter than the length Lf of the groove 107f. In addition, a length Li of the groove 107i, which is arranged adjacently to the groove 107h and is arranged more outwardly than the groove 107h, is shorter than the length Lh of the groove 107h.

As described above, as long as a length of part of the groove 107D among the plurality of grooves 107D provided on the vamp 103D is arranged from the center 159 toward the outside (second direction D2), the same advantages as those of the first embodiment can be obtained. In other words, in the two grooves 107D adjacent to each other, a length of the groove 107D arranged on the outside (second direction D2) may be relatively shorter than a length of the groove 107D arranged on the center 159 side. Further, although not shown, in the two grooves 107D that are adjacent to each other, a length of the groove 107D arranged on the center 159 side and a length of the groove 107D arranged more outward (in second direction D2) may be the same.

### [Modification 2]

FIG. 13 is a partially enlarged view of a reed 10E according to a modification 2 as viewed from a tip 155E of a vamp 103E in the first direction (D1). The reed 10E has substantially the same configuration as the reed 10A according to the second embodiment, except that depths of the plurality of grooves 107E provided on the vamp 103E differ in part from the plurality of grooves 107A arranged in the reed 10A according to the second embodiment.

As shown in FIG. 13, in the reed 10E of the modification 2, a depth of part of the groove 107E in the plurality of grooves 107E provided on the vamp 103E is deeper as it is arranged outwardly from the center 159 (toward the second direction D2). For example, in the groove 107a to the groove 107e, when a depth Da of the groove 107a arranged closest to the center 159 is compared with a depth Dc of the groove 107c arranged more outwardly than the groove 107a, the depth Dc of the groove 107c is deeper than the depth Da of the groove 107a. Similarly, when the depth Dc of the groove 107c is compared with a depth De of the outermost groove 107e, the depth De of the groove 107e is deeper than the depth Dc of the groove 107c. On the other hand, a depth Db of the groove 107b which is arranged adjacent to the groove 107a and is arranged more outwardly than the groove 107a is shallower than the depth Da of the groove 107a. Further, a depth Dd of the groove 107d which is arranged adjacent to the groove 107c and is arranged more outwardly than the groove 107c is shallower than the depth Dc of the groove 107c.

Although not shown, in the reed 10E, among the grooves 107f to 107j which are arranged at an opposite side of the grooves 107a to 107e with the center 159 interposed therebetween, when a depth of the groove 107f arranged closest to the center 159 side is compared with a depth of the groove 107E arranged more outwardly than the groove 107f, the depth of the groove 107E (at least one of the grooves 107g to 107j) which is arranged more outwardly is deeper than the depth of the groove 107f. Further, another groove 107E may be arranged between the groove 107f and the groove 107E arranged more outwardly than the groove 107f. A depth of another groove 107E may be shallower than the depth of the groove 107f.

As described above, as long as depths of part of the grooves 107E among the plurality of grooves 107E provided on the vamp 103E is deeper from the center 159 toward an outside (second direction D2), the same effects as those of the second embodiment can be obtained. In other words, in two groove 107E adjacent to each other, a depth of the groove 107E arranged on the outside (second direction D2) may be relatively shallower than a depth of the groove 107E arranged on the center 159 side. Further, although not shown, in two groove 107E that are adjacent to each other, a depth of the groove 107E arranged on the center 159 side and a depth of the groove 107E arranged on the outside (second direction D2) may be the same.

### [Modification 3]

Further, although not shown, in the reed 10B of the third embodiment, thicknesses of the bottom parts of the grooves 107a to 107j in the plurality of grooves 107B is gradually thinner in the grooves 107a to 107j from the groove 107a arranged closest to the center 159 or the groove 107e or the groove 107j arranged outermost from the groove 107f. However, thicknesses of bottom parts of part of the grooves 107B in the plurality of grooves 107B provided on the vamp 103B may be thinner so as to be arranged from the center 159 toward the outside (second direction D2).

### [Modification 4]

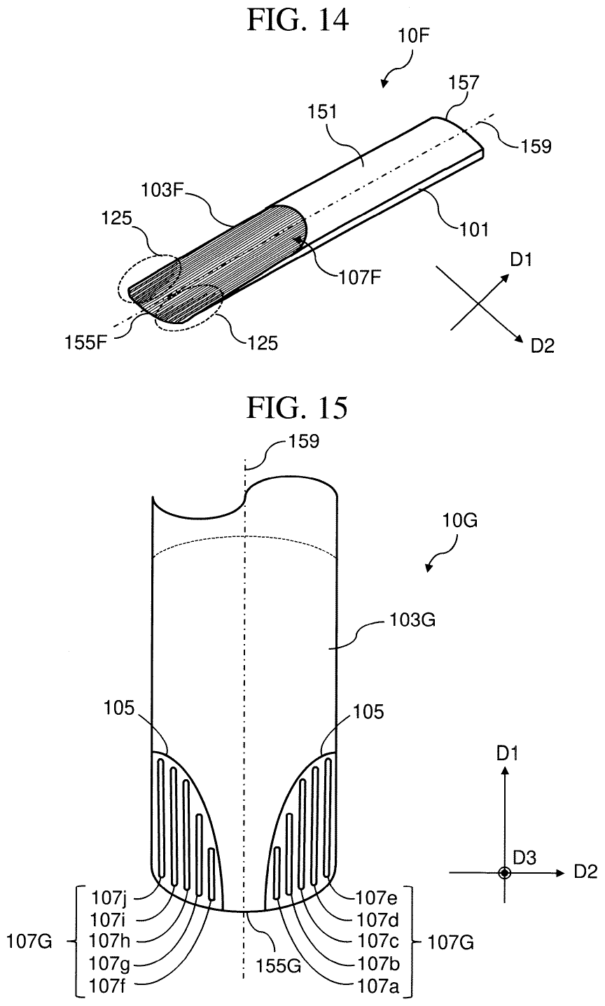

FIG. 14 is a diagram showing a reed 10F according to a fourth modification. Unlike the first to fourth embodiments described above, grooves 107F are provided on an entire vamp 103F of the reed 10F. In a modification 4, the grooves 107F are arranged so that a thickness of the vamp 103F gradually decreases from the center 159 toward an outside when a tip 155F of the vamp 103F is viewed in the first direction D1. In other words, the grooves 107F are formed so that a depth of the groove 107F becomes deeper toward an end part 125 of the vamp 103F.

As a result, on the tip 155F side of the vamp 103F, rigidity in the second direction D2 (lateral direction) that is perpendicular to the first direction D1 which is an extending direction (longitudinal direction) of the reed 10F from the center 159 of the vamp 103F toward the outside is lower than rigidity in the first direction D1 (longitudinal direction).

In addition, although not shown in the drawings, not limited to the tip 155F of the vamp 103F, grooves 107F may be arranged so that the thickness of the vamp 103F gradually decreases from the center 159 toward the outside in the entire vamp 103F.

Further, although not shown, the grooves 107F may be arranged in the entire reed 10F including the base part 101.

### [Modification 5]

In the first to fourth embodiments described above, although the case where the shapes of the plurality of grooves 107, 107A to 107C provided on the vamps 103, 103A to C are U-shape is shown, the shape of the grooves 107 may be a V-shape or a U-shape having right angles. Herein, “V-shaped” means a shape having two side surfaces, wherein the two side surfaces are connected at an acute angle. The “U-shape having right angles” means a shape comprising a bottom surface and two side surfaces, wherein angles formed by the bottom surface and the two side surfaces are each right angle.

### [Modification 6]

FIG. 15 is a plan view of a vamp 103G of a reed 10G according to a modification 6 as viewed in the third direction D3 perpendicular to the first direction D1 and the second direction D2. In the first to fourth embodiments described above, the case where the plurality of grooves 107, 107A to 107C provided on the vamps 103, 103A to C are each in contact with the tips 155, 155A to C of the vamp 103, 103A to C, and extend from the tips 155, 155A to C in the first direction D1 is shown as an example. However, as shown in FIG. 15, end parts of the plurality of grooves 107G arranged in the vamp 103G on a tip 155G side may be spaced apart from the tip 155G. Distances between the tip 155G and end parts of the plurality of grooves 107G on the tip 155G side may be 0.5 mm or more and 4 mm or less. In addition, in FIG. 15, the end parts of the plurality of grooves 107G on the tip 155G side are arranged to be aligned in the second direction D2 so as to conform be along a shape of the tip 155G. However, the end parts of the plurality of grooves 107G on the tip 155G side may not be along the shapes of the tip 155G.

### [Modification 7]

In the first to fourth embodiments described above, the plurality of grooves 107, 107A to 107C provided on the vamp 103, 103A to C are all extended in the first direction D1. However, an extending direction of a plurality of grooves is not limited to the first direction D1. For example, the plurality of grooves 107 may extend in any direction inclined by a predetermined angle from the first direction D1. The predetermined angle may be less than ±45°, excluding 0°, for example, within ±40°, excluding 0°.

In the case where the plurality of grooves 107 extend in any direction inclined by a predetermined angle from the first direction D1, the predetermined grooves and another groove different from the predetermined grooves among the plurality of grooves 107 may extend in different directions from each other. In addition, in the case where the plurality of grooves 107 extends in any direction inclined by a predetermined angle from the first direction D1, the plurality of grooves 107 may extend to end parts of both sides connected to the tip 155 of the vamp 103, that is, end parts of the vamp 103 in the second direction D2. Further, the plurality of grooves 107 may extend in a curved manner relative to the first direction D1. That is, when the vamp 103 is viewed in the third direction D3, the plurality of grooves 107 may have a curved shape.

### [Modification 8]

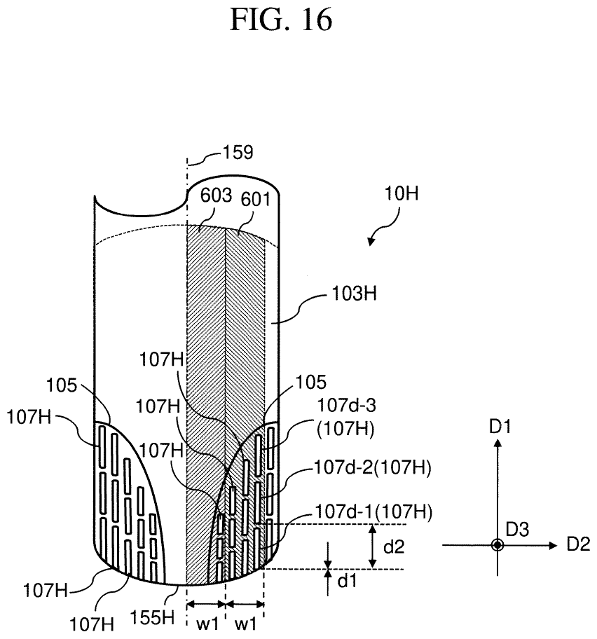

FIG. 16 is a plan view of a vamp 103H of a reed 10H according to an example of the eighth modification as viewed in the third direction D3 perpendicular to the first direction D1 and the second direction D2. In the first to fourth embodiments described above, the grooves 107a to 107j of the plurality of grooves 107, 107A to 107C provided on the vamp 103, 103A to C are each one groove extending continuously in the first direction D1. However, each of the plurality of grooves 107, 107A to 107C may include at least a first groove and a second groove that are discontinuous with each other.

The vamp 103H includes a first region 601 extending in the first direction D1 with a predetermined width w1 in the second direction D2. The first region 601 includes at least one groove 107H. Here, in the groove 107H included in the first region 601, the entire groove 107H may be arranged in the first region 601, or at least part of the groove 107H may be arranged in the first region 601. In FIG. 16, as an example, the first region 601 includes nine grooves 107H including a predetermined groove (first groove) and another groove (second groove) spaced apart from the predetermined groove. For example, the first region 601 includes a groove 107d-1 contact to a tip 155H of the vamp 103H and a groove 107d-2 spaced apart from the groove 107d-1. That is, a first distance d1 between the groove 107d-1 and the tip 155H is smaller than a second distance d2 between the groove 107d-2 and the tip 155H. In other words, the groove 107d-1 and the groove 107d-2 are discontinuous. Here, since the groove 107d-1 is in contact with the tip 155H, the first distance d1 is 0. Similarly, the first region 601 may include a groove 107d-3 spaced apart from the tip 155H and adjacent to the groove 107d-2, and a distance between the groove 107d-3 and the tip 155H may be greater than the second distance d2.

In FIG. 16, the mutually discontinuous grooves 107d-1, 107d-2, and 107d-3 extend coaxially in the first direction D1. However, a predetermined groove and another groove different from the predetermined groove in the plurality of grooves 107H including the grooves 107d-1, 107d-2, and 107d-3 may extend in different directions from each other. For example, each of the plurality of grooves 107H may extend in any direction that is inclined by a predetermined angle from the first direction D1. The predetermined angle may be less than ±45°, excluding 0°, for example, within ±40°, excluding 0°.

As shown in FIG. 16, the vamp 103H includes a second region 603 located closer to the center 159 than the first region 601 and having a predetermined width w1 in the second direction D2 and extending in the first direction D1. When the vamp 103H is viewed in the third direction D3, a surface area of grooves included in the first region 601 is larger than a surface area of grooves included in the second region 602. That is, in the vamp 103H of the reed 10H, the plurality of grooves 107H is arranged so that a ratio of a surface area of the groove 107H to a surface area of the vamp 103H gradually increases from the center 159 toward the outside. The second region 603 may be a region including the center 159. In this case, the second region 603 may not include the groove 107H depending on a size of the width w1 of the second direction D2. In the case where the second region 603 does not include the groove 107H, the number of grooves included in the second region 603 is assumed to be 0.

Further, each of the plurality of grooves 107H may have circular outer edges. Here, the plurality of grooves 107H is arranged such that the ratio of the surface area of the plurality of grooves 107H to the surface area of the vamp 103H increases from the center 159 toward the outside. In this case, as shown in FIG. 16, the numbers of the plurality of grooves 107H may increase from the center 159 toward the outside. Further, although not shown, in the case where the plurality of grooves 107H have circular outer edges, diameters of the plurality of grooves 107H may gradually increase from the center 159 toward the outside. In the case where the plurality of grooves 107H have the circular outer edges, density of the grooves 107H in the vamp 103H can be finely adjusted as compared with grooves having a longitudinal direction in an extending direction, and strength of the vamp 103H can be easily adjusted.

### [Modification 9]

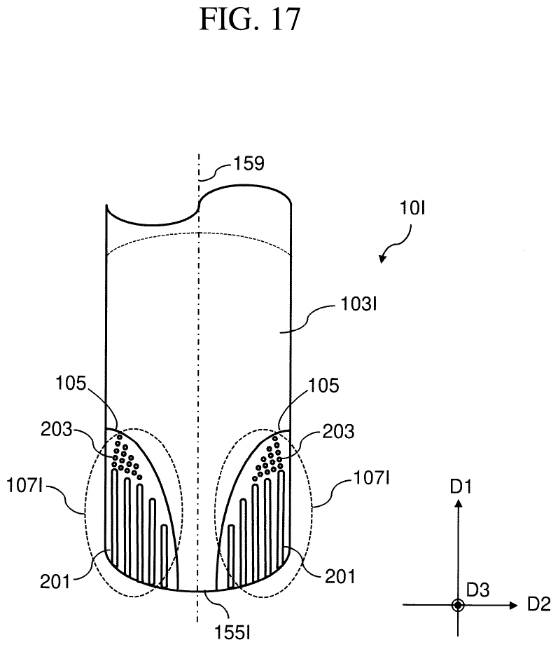

FIG. 17 is a plan view of a vamp 103I of a reed 10I according to a modification 9 as viewed in the third direction D3. As shown in FIG. 17, a plurality of grooves 107I are formed in the vamp 103I. In the modification 9, the plurality of grooves 107I includes a plurality of grooves 201 having a longitudinal direction in an extending direction and a plurality of grooves 203 having circular outer edges. As shown in FIG. 17, the plurality of grooves 201 may extend in the first direction D1, or may extend in any direction inclined by a predetermined angle from the first direction D1. The plurality of grooves 203 may be arranged adjacently to a second end part of the groove 201 opposite to the first end part on a tip 155I side. Although not shown, the plurality of grooves 203 may be arranged adjacent to the tip 155I side, and the plurality of grooves 201 may be arranged adjacent to the plurality of grooves 203 and spaced apart from the tip 155I.

In FIG. 17, although the plurality of grooves 107I includes the plurality of grooves 203 having circular outer edges, instead of the plurality of grooves 203 having a circular shape, a plurality of grooves having a longitudinal direction in an extending direction and a length in the longitudinal direction smaller than the grooves 201 may be arranged. Such grooves may extend in the same direction as the plurality of grooves 201 or may extend in a direction different from the plurality of grooves 201. Further, such grooves may be formed so that the length in the longitudinal direction gradually increases from the center 159 toward the outside.

### [Modification 10]

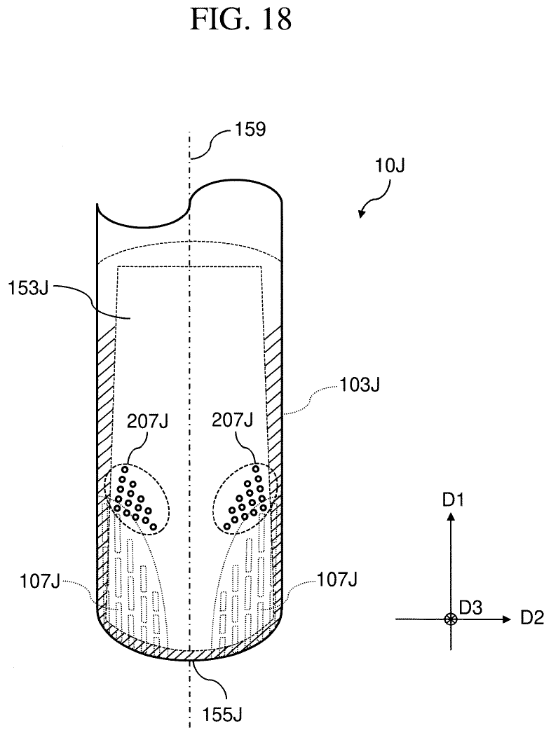

FIG. 18 is a plan view of a back surface 153J of a reed 10J according to a modification 10 as viewed in the third direction D3. FIG. 18 shows a region corresponding to a vamp 103J of the reed 10J on the back surface 153J. In the reed 10J, a plurality of groove 207J is formed on the back surface 153J in addition to the vamp 103J.

In FIG. 18, although the plurality of groove 207J arranged on the back surface 153J having circular outer edges is shown as an example, instead of these grooves 207J, grooves having a longitudinal direction in an extending direction may be arranged. The plurality of grooves 207J may or may not overlap the plurality of grooves 107J provided on the vamp 103J of the reed 10J. The grooves 207J are formed so as not to penetrate through the plurality of grooves 107J in the case where the grooves 207J overlap any of the plurality of grooves 107J provided on the vamp 103J. Further, in order to ensure airtightness of the blowing part 1, in the back surface 153J, the plurality of groove 207J is not arranged in a part (a region indicated by a hatched line in FIG. 18) of the mouthpiece 30 that contacts the tip rail 300 and the side rails 303. The plurality of grooves 207J are preferably arranged on an inner side of a region indicated by the hatched line in FIG. 18.

What is claimed is:

1. A reed comprising:
a base part extending in a first direction;
a vamp extending from the base part in the first direction; and
a plurality of grooves formed on the vamp and aligned in a second direction perpendicular to the first direction,
wherein a first region of the vamp having a predetermined width in the second direction and extending in the first direction includes at least a part of a first groove when the vamp is viewed along a third direction perpendicular to the first direction and the second direction, and
wherein a surface area of a groove in the first region is larger than a surface area of a groove in a second region which is located closer to a center of the vamp than the first region and extends in the first direction with a predetermined width in the second direction when the vamp is viewed along the third direction.

2. The reed according to claim 1, further comprising a second groove arranged in the second region, wherein a length of the first groove along the first direction is longer than a length of the second groove along the first direction.

3. The reed according to claim 1, further comprising:
a second groove arranged in second region; and
a third groove and a fourth groove arranged closer to the center of the vamp than the second groove when the vamp is viewed along the third direction,
wherein the first groove, the second groove, the third groove and the fourth groove arranged in order from an outside of the vamp to the center of the vamp when the vamp is viewed along the first direction,
and wherein a distance between the third groove and the fourth groove is greater than a distance between the first groove and the second groove.

4. A reed comprising:
a base part extending in a first direction;
a vamp extending from the base part in the first direction; and
a plurality of grooves formed on the vamp, the plurality of grooves including at least a first groove and a second groove arranged in order from a center of the vamp to an outside of the vamp when the vamp is viewed along the first direction,
wherein a cross-sectional area of the second groove, when the vamp is viewed along the first direction, is larger than a cross-sectional area of the first groove, when the vamp is viewed along the first direction.

5. The reed according to claim 4, wherein a depth of the first groove is deeper than a depth of the second groove.

6. The reed according to claim 4, wherein a width of the first groove is wider than a width of the second groove when the vamp is viewed in the first direction.

7. A reed comprising:
a base part extending in a first direction;
a vamp extending from the base part in the first direction; and
a plurality of grooves formed on the vamp, the plurality of grooves including at least a first groove and a second groove arranged in order from a center of the vamp to an outside of the vamp when the vamp is viewed along the first direction,
wherein a thickness of a bottom part of the second groove is thinner than a thickness of a bottom part of the first groove.

8. The reed according to claim 1, wherein
the first region further includes at least a part of a second groove separated from the first groove, and
a first distance between an end of the first groove, which is located on a tip side of the vamp, and a tip of the vamp is less than a second distance between an end of the second groove, which is located on the tip side of the vamp, and the tip of the vamp.

9. The reed according to claim 8, wherein the second region includes a center of the vamp in the second direction.

10. The reed according to claim 2, wherein at least one of the plurality of grooves extends along the first direction.

11. The reed according to claim 2, wherein at least one of the plurality of grooves extends along any direction inclined from the first direction by more than 0° and less than ±45°, respectively.

12. The reed according to claim 11, wherein the plurality of grooves has at least two grooves extending in different directions from each other.

13. The reed according to claim 2, wherein at least one of the plurality of grooves is bent and extends in the first direction.

14. The reed according to claim 2, wherein the vamp becomes thinner from the center of the vamp toward an outside of the vamp when the vamp is viewed along the first direction.

15. The reed according to claim 2, wherein the vamp is made of resin material.

16. The reed according to claim 2, wherein the vamp is made of plant material.

17. The reed according to claim 2, wherein at least one of the plurality of grooves extends from a tip of the vamp in the first direction.

18. The reed according to claim 8, wherein the first groove and the second groove each have a circular outer edge.

19. The reed according to claim 2, wherein
the vamp extends from a first surface of the base part, and
a second surface of the base part, which is an opposite side of the first surface, has a plurality of grooves formed in a region corresponding to the vamp.
